(19) United States
(12) Patent Application Publication
(10) Pub. No.: US 2024/0332501 A1
(43) Pub. Date: Oct. 3, 2024

(54) Negative Electrode Composite Material, Preparation Method Thereof, Negative Electrode and Lithium-Ion Secondary Battery

(71) Applicant: MURATA MANUFACTURING CO., LTD., Kyoto (JP)

(72) Inventors: Li WANG, Shanghai (CN); Yan Zhou, Shanghai (CN); Yuli LI, Shanghai (CN); Kazumasa TAKESHI, Shanghai (CN)

(21) Appl. No.: 18/612,265

(22) Filed: Mar. 21, 2024

(30) Foreign Application Priority Data
Mar. 30, 2023 (CN) 202310332070.6

(51) Int. Cl. H01M 4/36; H01M 4/02; H01M 4/48; H01M 4/485; H01M 4/62; H01M 10/0525

(52) U.S. Cl. CPC H01M 4/364; H01M 4/366; H01M 4/483; H01M 4/485; H01M 4/625; H01M 10/0525; H01M 2004/021; H01M 2004/027

(57) ABSTRACT

The present invention provides a negative electrode composite material, a preparation method thereof, a negative electrode and a lithium ion secondary battery. The negative electrode composite material comprises: negative electrode active material particulates and Li₂CO₃ and LiOH at the surface of the negative electrode active material particulates, the negative electrode active material particulates comprise: particles containing silicon oxide, Li₂SiO₃ and Li₂Si₂O₅; and a carbon coating layer coating at least a part of surface of the particles, based on the weight of the negative electrode active material particulates, the content of Li₂CO₃ is greater than about 0.01 wt % and less than about 1 wt %, the content of LiOH is greater than about 0.001 wt % and less than about 0.1 wt %, and the weight ratio of Li₂Si₂O₅ to Li₂SiO₃, i.e. Li₂Si₂O₅/Li₂SiO₃ is in the range of about 1.00 to about 10.00. By the negative electrode composite material, the preparation method thereof, the negative electrode and the lithium-ion secondary battery of the present invention, the residual lithium amount can be effectively reduced, the processing performance of the slurry can be improved, and the initial Coulombic efficiency and cycle performance of the lithium-ion secondary battery can be improved.

The present application claims a priority to Chinese patent application no. 202310332070.6, filed on Mar. 30, 2023, the entire contents of which are incorporated herein by reference.

### TECHNICAL FIELD

The present invention relates to the field of lithium-ion secondary batteries, and in particular, to a negative electrode composite material, a method for preparing the negative electrode composite material, and a negative electrode and a lithium-ion secondary battery which contain the negative electrode composite material.

### BACKGROUND

In recent years, along with the continuous development of electronic technology, demand of people for a battery apparatus supporting energy supply of an electronic device is also increasing continuously. Today, batteries capable of storing more electric quantity and capable of outputting high power are needed. Conventional lead-acid batteries and nickel-hydrogen batteries, etc. have been unable to meet the requirements of new electronic products such as mobile devices such as smart phones and fixed device such as electric power storage systems, etc. . . . Therefore, lithium-ion secondary batteries have attracted people's wide attention. In the development of lithium-ion secondary batteries, the capacity and performance thereof have been improved effectively. The lithium-ion secondary battery has advantages such as high energy density, high working voltage, long cycle life, and low environmental pollution, etc., and has become a new green high-energy chemical power source with extremely high development potential in the current world.

The lithium-ion secondary battery comprises a positive electrode, a negative electrode containing a negative electrode material, and an electrolyte. Various types of negative electrode materials have been developed, with silicon-based negative electrode materials being one of promising negative electrode materials. The prior art discloses that a pre-lithiation technology is used to improve the performance of the silicon-based negative electrode material, and the residual lithium amount of the silicon-based negative electrode material is controlled; however, in the prior art, the upper limit and the lower limit for controlling the residual lithium amount of the silicon-based negative electrode material are both high, it is difficult to improve the processing performance of a slurry containing a negative electrode material, and it is difficult to effectively improve the initial Coulombic efficiency and cycle performance of the lithium-ion secondary battery. Therefore, it is necessary to develop a novel negative electrode composite material, a method for preparing the negative electrode composite material, and a negative electrode and a lithium-ion secondary battery which contain the negative electrode composite material.

### SUMMARY

A main object of the present invention is to provide a negative electrode composite material, a method for preparing the negative electrode composite material, and a negative electrode and a lithium-ion secondary battery which contain the negative electrode composite material, so as to solve the problems in the prior art that the residual lithium amount of the negative electrode material is too high, it is difficult to improve the processing performance of a slurry, and it is difficult to effectively improve the initial Coulombic efficiency and cycle performance of the lithium-ion secondary battery.

In order to achieve the object, according to one aspect of the present invention, provided is a negative electrode composite material, the negative electrode composite material comprising negative electrode active material particulates and Li₂CO₃ and LiOH at the surface of the negative electrode active material particulates, the negative electrode active material particulates comprise: particles containing silicon oxide, Li₂SiO₃ and Li₂Si₂O₅; and a carbon coating layer coating at least a part of surface of the particles, based on the weight of the negative electrode active material particulates, the content of Li₂CO₃ is greater than about 0.01 wt % and less than about 1 wt %, the content of LiOH is greater than about 0.001 wt % and less than about 0.1 wt %, and the weight ratio of Li₂Si₂O₅ to Li₂SiO₃, i.e. Li₂Si₂O₅/Li₂SiO₃ is in the range of about 1.00 to about 10.00.

Further, in the negative electrode composite material, based on the weight of the negative electrode active material particulates, the content of Li₂SiO₃ is greater than about 1.0 wt % and less than about 48.0 wt %.

Further, in the negative electrode composite material, within the particle, Li₂SiO₃ is distributed in a tendency of gradually decreasing toward the center of the particle from a position close to the surface of the particle, and Li₂Si₂O₅ is distributed at a position closer to the center of the particle than Li₂SiO₃.

Further, in the negative electrode composite material, the carbon coating layer coats the entire surface of the particles.

Further, in the negative electrode composite material, the silicon oxide is SiOₓ, where about 0.5≤x≤about 1.6.

Further, in the negative electrode composite material, silicon in the silicon oxide exists in the form of crystalline silicon, and the size of the crystalline silicon is in the range of about 5.0 nm to about 12.0 nm.

Further, in the negative electrode composite material, the intensity ratio of a D peak to a G peak, i.e. I_{D}/I_{G} in a Raman spectrum of the negative electrode composite material is greater than about 0.8 and less than about 2.0, preferably greater than about 1.5 and less than about 1.8.

Further, in the negative electrode composite material, the coating amount of the carbon coating layer is in the range of about 1 wt % to about 30 wt % based on the weight of the negative electrode active material particulates.

According to another aspect of the present invention, provided is a method for preparing a negative electrode composite material, the method comprising: performing carbon coating treatment on a silicon oxide precursor by using a carbon source, to form carbon-coated silicon oxide; mixing the carbon-coated silicon oxide with a lithium source to form a first mixture, performing a first heat treatment on the first mixture to form a calcined product, and then performing a second heat treatment on the calcined product to form a pre-lithiated product; and performing a washing treatment on the pre-lithiated product to form a negative electrode composite material.

Further, in the method for preparing the negative electrode composite material, the washing treatment comprises mixing the pre-lithiated product with water, alcohol or an acid, preferably at a solid content of about 5 wt % to about 20 wt %, to form a second mixture, performing an ultrasonic treatment on the second mixture, then dispersing same, subsequently performing suction filtration, and finally drying the substances after suction filtration.

Further, in the method for preparing the negative electrode composite material, the acid is selected from at least one of hydrochloric acid, citric acid, oxalic acid, phosphoric acid, sulfurous acid, acetic acid, chloric acid, hypochlorous acid and boric acid.

Further, in the method for preparing the negative electrode composite material, the weight ratio of the lithium source to the carbon-coated silicon oxide is in the range of about 5:95 to about 40:60.

Further, in the method for preparing the negative electrode composite material, the temperature of performing the first heat treatment is in the range of about 400° C. to about 750° C., and the time of performing the first heat treatment is in the range of about 1 h to about 5 h.

Further, in the method for preparing the negative electrode composite material, the temperature of performing the second heat treatment is in the range of greater than or equal to about 800° C. and less than about 925° C., and the time of performing the second heat treatment is in the range of about 1 h to about 6 h.

Further, in the method for preparing the negative electrode composite material, the time of performing the ultrasonic treatment is in the range of about 1 min to about 30 min.

Further, in the method for preparing the negative electrode composite material, the time for dispersion is in the range of about 8 h to about 48 h.

Further, in the method for preparing the negative electrode composite material, the carbon source comprises at least one of an alkane, an olefin and an alkyne.

Further, in the method for preparing the negative electrode composite material, the alcohol is selected from at least one of ethanol, isopropanol and butanol.

According to still another aspect of the present invention, provided is a negative electrode of a lithium-ion secondary battery, the negative electrode of the lithium-ion secondary battery comprises the negative electrode composite material as described above.

According to yet another aspect of the present invention, provided is a lithium-ion secondary battery, the lithium-ion secondary battery comprising: a positive electrode, a negative electrode and a separator, the negative electrode contains the negative electrode composite material as described above.

By the negative electrode composite material, the method for preparing the negative electrode composite material, and the negative electrode and the lithium-ion secondary battery which contain the negative electrode composite material in the present invention, the residual lithium amount can be effectively reduced, the processing performance of the slurry can be improved, and the initial Coulombic efficiency and cycle performance of the lithium-ion secondary battery can be improved.

### BRIEF DESCRIPTION OF THE DRAWINGS

FIG. 1 shows a schematic structural diagram of a negative electrode composite material according to an embodiment of the present invention.

FIG. 2 shows a relationship diagram between the size of crystalline silicon and the weight ratio of Li₂Si₂O₅ to Li₂SiO₃, i.e. Li₂Si₂O₅/Li₂SiO₃ in negative electrode composite materials in Examples 1-10 and Comparative Examples 1-3, 5, 7 and 9, in which the ordinate is the size of crystalline silicon in the negative electrode composite material, and the abscissa is the weight ratio of Li₂Si₂O₅ to Li₂SiO₃, i.e. Li₂Si₂O₅/Li₂SiO₃.

FIG. 3 is a relationship diagram between the discharge capacity retention rate after 50 cycles (%) and the intensity ratio of a D peak to a G peak, i.e. I_{D}/I_{G} in a Raman spectrum of negative electrode composite materials in Examples 1-8 and Comparative Examples 1, 3, 4, 6, 8 and 9, in which the ordinate is the discharge capacity retention rate after 50 cycles (%), and the abscissa is the intensity ratio of a D peak to a G peak, i.e. I_{D}/I_{G} in a Raman spectrum of the negative electrode composite material.

FIG. 4 shows a spectrogram of Li 1s XPS (X-ray photoelectron spectroscopy) of different etching depths of Example 2.

FIG. 5 shows a spectrogram of Li 1s XPS (X-ray photoelectron spectroscopy) of different etching depths of Comparative Example 1.

### DETAILED DESCRIPTION OF THE EMBODIMENTS

It is to be noted that embodiments in the present application and features in the embodiments may be combined with one another without conflicts. Hereinafter, the present invention will be described in detail with reference to embodiments. The following embodiments are merely exemplary, and are not intended to limit the scope of protection of the present invention.

As explained in the Background, in the prior art, the residual lithium amount of the negative electrode material is too high, it is difficult to improve the processing performance of a slurry containing the negative electrode material, and it is difficult to effectively improve the initial Coulombic efficiency and cycle performance of the lithium-ion secondary battery. In view of the problems in the prior art, a typical embodiment of the present invention provides a negative electrode composite material, the negative electrode composite material comprising negative electrode active material particulates and Li₂CO₃ and LiOH at the surface of the negative electrode active material particulates, the negative electrode active material particulates comprise: particles containing silicon oxide, Li₂SiO₃ and Li₂Si₂O₅; and a carbon coating layer coating at least a part of surface of the particles, based on the weight of the negative electrode active material particulates, the content of Li₂CO₃ is greater than about 0.01 wt % and less than about 1 wt %, the content of LiOH is greater than about 0.001 wt % and less than about 0.1 wt %, and the weight ratio of Li₂Si₂O₅ to Li₂SiO₃, i.e. Li₂Si₂O₅/Li₂SiO₃ is in the range of about 1.00 to about 10.00.

A higher residual lithium value may affect the processing performance of the slurry containing the negative electrode composite material, rendering that the slurry tends to “jellify” during the preparation of the slurry by using the negative electrode composite material. In the prior art, people have not been aware of the effects of the distribution of a lithium-containing compound and the weight ratio of Li₂Si₂O₅ to Li₂SiO₃, i.e. Li₂Si₂O₅/Li₂SiO₃ on the control of residual lithium. After carrying out a large number of experiments, the inventor of the present invention has surprisingly found that by designing the distribution of the lithium-containing compound in the negative electrode composite material and by regulating the weight ratio of Li₂Si₂O₅ to Li₂SiO₃, i.e. Li₂Si₂O₅/Li₂SiO₃, not only the size of crystalline silicon can be regulated, but also the control and optimization of residual lithium are facilitated, the residual lithium amount can be effectively reduced, “jellification” of a slurry during the preparation of the slurry by using the negative electrode composite material can be avoided, the processing performance of the slurry can be improved, and the initial Coulombic efficiency and cycle performance of the lithium-ion secondary battery can be improved. Therefore, the negative electrode composite material of the present invention has a significantly-reduced residual lithium amount, can improve the processing performance of the slurry, and can improve the initial Coulombic efficiency and cycle performance of the lithium-ion secondary battery.

In some embodiments of the present invention, in the negative electrode composite material of the present invention, based on the weight of the negative electrode active material particulates, the content of Li₂SiO₃ is greater than about 1.0 wt % and less than about 48.0 wt %. In the prior art, control of the amount of Li₂SiO₃ soluble in water is not explicit, and the effect of the amount of Li₂SiO₃ soluble in water on the electrochemical performance has not been deeply studied. The inventor of the present invention has surprisingly found that by controlling the content of Li₂SiO₃ within the range above, obtaining a sufficiently pre-lithiated negative electrode composite material can be ensured, and the initial Coulombic efficiency and cycle performance of the lithium-ion secondary battery can be improved.

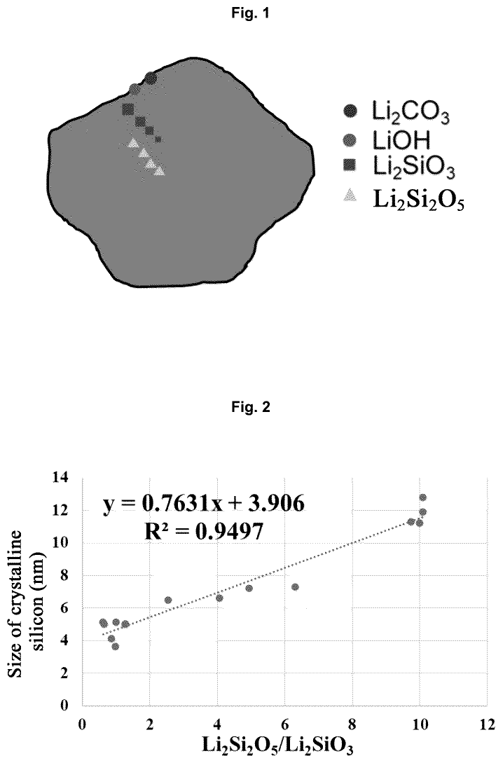

In some embodiments of the present invention, in the negative electrode composite material of the present invention, within the particle, Li₂SiO₃ is distributed in a tendency of gradually decreasing toward the center of the particle from a position close to the surface of the particle, and Li₂Si₂O₅ is distributed at a position closer to the center of the particle than Li₂SiO₃. The distribution of the water-soluble Li₂SiO₃ and the water-insoluble Li₂Si₂O₅ in the negative electrode composite material facilitates the control and optimization of the residual lithium, can effectively reduce the residual lithium amount, improve the processing performance of the slurry, and improve the initial Coulombic efficiency and cycle performance of the lithium-ion secondary battery. FIG. 1 shows a schematic structural diagram of a negative electrode composite material according to an embodiment of the present invention.

In some embodiments of the present invention, in the negative electrode composite material of the present invention, the carbon coating layer can coat the entire surface of the particles, so that the conductivity of the negative electrode composite material can be improved, the initial Coulombic efficiency is improved, the residual lithium amount is reduced more effectively, and the processing performance of the slurry is improved.

The silicon oxide of the present application can use conventional silicon oxide for a negative electrode material in the art. In some embodiments of the present invention, in the negative electrode composite material of the present invention, the silicon oxide may be SiOₓ, where about 0.5≤x≤about 1.6, preferably about 0.8≤x≤about 1.2, most preferably x=about 1.0.

In some embodiments of the present invention, in the negative electrode composite material of the present invention, silicon in the silicon oxide exists in the form of crystalline silicon, and the size of the crystalline silicon is in the range of about 5.0 nm to about 12.0 nm, and preferably, the size of the crystalline silicon is in the range of about 5.0 nm to about 11.5 nm. By controlling the size of crystalline silicon within the range above, it can be ensured that volume expansion of the negative electrode composite material is relatively small, good cycle performance can be obtained, and a good balance between reducing the residual lithium amount of the negative electrode composite material and improving the cycle performance of the lithium-ion secondary battery can be obtained.

In some embodiments of the present invention, in the negative electrode composite material of the present invention, the intensity ratio of a D peak to a G peak, i.e. I_{D}/I_{G} in a Raman spectrum of the negative electrode composite material is greater than about 0.8 and less than about 2.0, preferably greater than about 1.5 and less than about 1.8. By controlling the intensity ratio of a D peak to a G peak, i.e. I_{D}/I_{G} in a Raman spectrum of the negative electrode composite material within the range above, the conductivity of the carbon coating layer can be better, and the lithium-ion secondary battery can obtain better cycle performance. Peak intensities I_{D} and I_{G} of D band (˜1350 cm⁻¹) and G band (˜1580 cm⁻¹) can be respectively obtained by Raman spectroscopy test. The model of Raman equipment used is, for example, Renishaw Qontor, the range of wave number used is, for example, about 100 to about 1800 cm⁻¹, and the wavelength of the laser used is, for example, about 532 nm.

In some embodiments of the present invention, in the negative electrode composite material of the present invention, based on the weight of the negative electrode active material particulates, the coating amount of the carbon coating layer is in the range of about 1 wt % to about 30 wt %, preferably, the coating amount of the carbon coating layer is in the range of about 3 wt % to about 20 wt %, and more preferably, the coating amount of the carbon coating layer is in the range of about 5 wt % to about 10 wt %. By controlling the coating amount of the carbon coating layer within the ranges above, a good balance between the capacity of the material and the coating uniformity can be obtained.

In another typical embodiment of the present invention, provided is a method for preparing a negative electrode composite material, the method comprising: performing carbon coating treatment on a silicon oxide precursor by using a carbon source, to form carbon-coated silicon oxide; mixing the carbon-coated silicon oxide with a lithium source to form a first mixture, performing a first heat treatment on the first mixture to form a calcined product, and then performing a second heat treatment on the calcined product to form a pre-lithiated product; and performing a washing treatment on the pre-lithiated product to form a negative electrode composite material.

The method for preparing the negative electrode composite material of the present invention is beneficial to the control and optimization of residual lithium, can effectively reduce the residual lithium amount, can avoid “jellification” of a slurry during the preparation of the slurry by using the negative electrode composite material, can improve the processing performance of the slurry, can improve the initial Coulombic efficiency and cycle performance of the lithium-ion secondary battery, and can suppress gas production of the slurry. The negative electrode composite material obtained by the method according to the present invention has a significantly-reduced residual lithium amount, can improve the processing performance of the slurry, and can improve the initial Coulombic efficiency and cycle performance of the lithium-ion secondary battery.

The silicon oxide precursor, for example, SiOₓ (where about 0.5≤x≤about 1.6) in the present invention can be prepared by conventional methods in the art. In some embodiments of the present invention, the silicon oxide precursor can be prepared by the following process: mixing silicon powder of a certain particle size and silicon dioxide at a molar ratio of about 1.1:1, then placing same on a vibrator to vibrate for about 12 h until uniform mixing, taking about 1 kg of the uniformly mixed substances to press same into block bodies, then placing the block bodies on a vacuum sublimation furnace and heating same to a temperature of about 1200° C. to about 1500° C., and by adjusting the vacuum degree to be about 0 to about 30 Pa, the heating time to be about 8 h to about 10 h, the temperature at a collection end to be about 400° C. to about 800° C., preparing a block-shaped silicon oxide precursor; and placing the block-shaped silicon oxide precursor in a crusher for crushing to a millimeter level, then placing the silicon oxide precursor of a millimeter level in an airflow pulverizer for pulverization, and classifying powders with different particle sizes by means of an air flow classifier, and finally mixing large and small particles of the powders with different particle sizes to ultimately obtain the silicon oxide precursor with a required particle size.

In some embodiments of the present invention, in the method for preparing the negative electrode composite material, chemical vapor deposition is performed on the surface of the silicon oxide precursor by using at least one of an alkane, an olefin and an alkyne as a carbon source under a pressure of about 50 Pa to about 10000 Pa and a temperature of about 600° C. to about 1000° C., so as to perform carbon coating treatment on the silicon oxide precursor to form carbon-coated silicon oxide. In some embodiments of the present invention, the carbon coating treatment can be performed in equipments such as a rotary kiln, a fixed bed, or a fluidized bed.

In some embodiments of the present invention, in the method for preparing the negative electrode composite material, the washing treatment comprises mixing the pre-lithiated product with water, alcohol or an acid, preferably at a solid content of about 5 wt % to about 20 wt %, e.g. about 5 wt % to about 10 wt %, about 10 wt % to about 15 wt % or about 15 wt % to about 20 wt %, to form a second mixture, performing an ultrasonic treatment on the second mixture, then dispersing same, subsequently performing suction filtration, and finally drying the substances after suction filtration. During the washing treatment, alkaline substances such as Li₂CO₃, LiOH and Li₂SiO₃ can be dissolved by using water, LiOH can be slightly dissolved by using the alcohol, and alkaline generated on the surface of the pre-lithiated product during washing can be neutralized by using the acid; and by the ultrasonic treatment, the pre-lithiated product can be washed more clean, thereby ensuring a good washing effect, the cycle performance of the lithium-ion secondary battery can be improved. The washing treatment can effectively reduce the residual lithium amount, can avoid “jellification” of the slurry during the preparation of the slurry by using the negative electrode composite material, can improve the processing performance of the slurry, and can further improve the initial Coulombic efficiency and cycle performance of the lithium-ion secondary battery. Since Li₂Si₂O₅ is insoluble in water and Li₂SiO₃ is soluble in water, the weight ratio of Li₂Si₂O₅ to Li₂SiO₃, i.e. Li₂Si₂O₅/Li₂SiO₃ can also be regulated by the washing treatment.

In some embodiments of the present invention, the prepared pre-lithiated product, e.g., pre-lithiated SiOₓ (about 0.5≤x≤about 1.6) material is mixed with water at a solid content of about 5 wt % to about 20 wt % to form a second mixture, an ultrasonic treatment is first performed on the second mixture at room temperature for about 1 min to about 30 min; and then a magnetic stirrer is used to disperse the second mixture for about 8 h to about 48 h, then suction filtration is performed, and after the suction filtration, pure water is poured onto the substances on filter paper, and washing is performed twice in the form of suction filtration, finally, vacuum drying is performed at about 100° C. to about 120° C. for about 3 to about 8 hours on the substances after suction filtration.

In some embodiments of the present invention, in the method for preparing the negative electrode composite material, in order to better neutralize alkali produced on the surface of the pre-lithiated product during washing, the acid is selected from at least one of hydrochloric acid, citric acid, oxalic acid, phosphoric acid, sulfurous acid, acetic acid, chloric acid, hypochlorous acid and boric acid.

In some embodiments of the present invention, the prepared pre-lithiated product, e.g., pre-lithiated SiOₓ (about 0.5≤x≤about 1.6) material is mixed with at least one of hydrochloric acid, citric acid, oxalic acid, phosphoric acid, sulfurous acid, acetic acid, chloric acid, hypochlorous acid and boric acid, etc. (e.g. citric acid at a concentration of about 1 mol/L) at a solid content of about 5 wt % to about 20 wt % to form a second mixture, an ultrasonic treatment is first performed on the second mixture at room temperature for about 1 min to about 30 min; and then a magnetic stirrer is used to disperse the second mixture for about 8 h to about 48 h, then suction filtration is performed, and after the suction filtration, pure water is poured onto the substances on filter paper, and washing is performed twice in the form of suction filtration, finally, vacuum drying is performed at about 100° C. to about 120° C. for about 3 to about 8 hours on the substances after suction filtration.

In some embodiments of the present invention, in the method for preparing the negative electrode composite material, the weight ratio of the lithium source to the carbon-coated silicon oxide is in the range of about 5:95 to about 40:60. By controlling the weight ratio of the lithium source to the carbon-coated silicon oxide to be in the described range, it can be ensured that the silicon oxide is sufficiently pre-lithiated, the residual lithium amount can be reduced, and the initial Coulombic efficiency and cycle performance of the lithium-ion secondary battery can be further improved. In some embodiments of the present invention, the lithium source may comprise any one of lithium ingot, lithium metal powder and lithium foil.

In some embodiments of the present invention, in the method for preparing the negative electrode composite material, the temperature of performing the first heat treatment is in the range of about 400° C. to about 750° C., and the time of performing the first heat treatment is in the range of about 1 h to about 5 h. By controlling the temperature and time of performing the first heat treatment within the described ranges, sufficient pre-lithiation of silicon oxide can be ensured, the residual lithium amount can be reduced, and the initial Coulombic efficiency and cycle performance of the lithium-ion secondary battery can be further improved.

In some embodiments of the present invention, in the method for preparing the negative electrode composite material, the temperature of performing the second heat treatment is in the range of greater than or equal to about 800° C. and less than about 925° C., and the time of performing the second heat treatment is in the range of about 1 h to about 6 h. By controlling the temperature and time of performing the second heat treatment within the described ranges, sufficient pre-lithiation of silicon oxide can be ensured, the size of crystalline silicon can be prevented from being too large, the residual lithium amount can be effectively reduced, and the initial Coulombic efficiency and cycle performance of the lithium-ion secondary battery can be further improved.

In some embodiments of the present invention, a lithium source and carbon-coated silicon oxide are ground and mixed at a weight ratio of about 5:95 to about 40:60 under the protection of an inert argon atmosphere to form a first mixture, then the first mixture is placed in a rotary kiln and calcined for 1 h-5 h under heat preservation at about 400° C. to about 750° C. and under an argon atmosphere, such that the carbon-coated silicon oxide is fully reacted with the lithium metal, and then heat treatment is performed at about 800° C. to about 924° C. for about 1 h to about 6 h, to regulate the pre-lithiation depth and the amount of lithium-containing silicate, so as to obtain the pre-lithiated product.

In some embodiments of the present invention, in the method for preparing the negative electrode composite material, the time of performing the ultrasonic treatment is in the range of about 1 min to about 30 min. By controlling the time of performing the ultrasonic treatment to be within the described range, the pre-lithiated product can be washed more clean, and a good washing effect is ensured; moreover, damage to the particles of the pre-lithiated product can be avoided.

In some embodiments of the present invention, in the method for preparing the negative electrode composite material, mainly in consideration of energy consumption, time cost and washing effect, the time for dispersion may be controlled within the range of about 8 h to about 48 h. If the time for dispersion is too short, the washing may be not thorough; and if the time for dispersion is too long, energy consumption and time cost will be high. By controlling the time for dispersion to be within the described range, not only a good washing effect can be ensured, but also the energy consumption and time cost can be reduced.

In some embodiments of the present invention, in the method for preparing the negative electrode composite material, in order to better achieve carbon coating on at least a part of the surface of the silicon oxide and obtain a good coating effect, the carbon source comprises at least one of an alkane, an olefin and an alkyne.

In some embodiments of the present invention, in the method for preparing the negative electrode composite material, the alcohol may be selected from at least one of ethanol, isopropanol and butanol, so as to obtain a better washing effect. The alcohol is preferably ethanol, which can slightly dissolve LiOH. In the case of using ethanol for cleaning, since ethanol is easy to volatilize, it is beneficial for drying in subsequent steps. Water is generally contained in ethanol, and water contained in ethanol can dissolve alkaline substances such as Li₂CO₃, LiOH and Li₂SiO₃. As ethanol, ethanol of about 75% concentration is generally used.

In some embodiments of the present invention, the prepared pre-lithiated product, e.g., pre-lithiated SiOₓ (about 0.5≤x≤about 1.6) material is mixed with at least one of ethanol, isopropanol and butanol and the like at a solid content of about 5 wt % to about 20 wt % to form a second mixture, an ultrasonic treatment is first performed on the second mixture at room temperature for about 1 min to about 30 min; and then a magnetic stirrer is used to disperse the second mixture for about 8 h to about 48 h, then suction filtration is performed, and after the suction filtration, pure water is poured onto the substances on filter paper, and washing is performed twice in the form of suction filtration, finally, vacuum drying is performed at about 100° C. to about 120° C. for about 3 to about 8 hours on the substances after suction filtration.

In still another typical embodiment of the present invention, provided is a negative electrode of a lithium-ion secondary battery, the negative electrode of the lithium-ion secondary battery comprises the negative electrode composite material as described above. As the negative electrode of the lithium-ion secondary battery of the present invention comprises the negative electrode composite material as described above, the residual lithium amount can be effectively reduced, the processing performance of the slurry can be improved, and the initial Coulombic efficiency and cycle performance of the lithium-ion secondary battery can be improved.

A negative electrode sheet of the present invention can be prepared according to conventional methods in the art. For example, the negative electrode composite material of the present invention, a conductive agent and a binder may be dispersed in water as a solvent to form a uniform negative electrode slurry, the negative electrode slurry is coated on a negative electrode current collector, and after drying, a negative electrode sheet is obtained. The conductive agent may be conductive carbon black, conductive graphite, vapor grown carbon fibers, carbon nanotubes, or any combination thereof. The binder may be one or more of styrene-butadiene rubber (SBR), polyacrylic acid (PAA), and polyimide (PI), etc., and is preferably a polyacrylic acid (PAA) binder.

In yet another typical embodiment of the present invention, provided is a lithium-ion secondary battery, the lithium-ion secondary battery comprising: a positive electrode, a negative electrode and a separator, the negative electrode contains the negative electrode composite material as described above. As the lithium-ion secondary battery of the present invention comprises the negative electrode composite material as described above, the residual lithium amount can be effectively reduced, the processing performance of the slurry can be improved, and the initial Coulombic efficiency and cycle performance of the lithium-ion secondary battery can be improved.

The positive electrode of the present invention comprises a positive electrode current collector and a positive electrode active material layer containing a positive electrode active material. The positive electrode active material layer is formed on both surfaces of the positive electrode current collector. A metal foil such as an aluminum foil, a nickel foil, or a stainless steel foil may be used as the positive electrode current collector.

The positive electrode active material layer contains one or more positive electrode materials capable of intercalating and de-intercalating lithium ions as the positive electrode active material, and may contain, as necessary, other material, for example, a positive electrode binder and/or a positive electrode conductive agent.

Preferably, the positive electrode material is a lithium-containing compound. Examples of such a lithium-containing compound comprise a lithium-transition metal composite oxide, a lithium-transition metal phosphate compound, and the like. The lithium-transition metal composite oxide is an oxide containing Li and one or two or more transition metal elements as constituent elements, and the lithium-transition metal phosphate compound is a phosphate compound containing Li and one or two or more transition metal elements as constituent elements. The transition metal element is advantageously one or more of Co, Ni, Mn and Fe, and the like.

Examples of the lithium-transition metal composite oxide may comprise, for example, LiCoO₂ and LiNiO2, and the like. Examples of the lithium-transition metal phosphate compound may comprise, for example, LiFePO₄ and LiFe₁₋ᵤMnᵤPO₄ (about 0<u<about 1), and the like.

The negative electrode of the present invention comprises a negative electrode current collector and a negative electrode active material layer containing a negative electrode composite material. The negative electrode active material layer is formed on both surfaces of the negative electrode current collector. A metal foil such as a copper (Cu) foil, a carbon-coated copper foil, a nickel foil, or a stainless steel foil may be used as the negative electrode current collector.

The separator of the present invention is used to separate the positive electrode from the negative electrode in the battery, and allow lithium ions to pass therethrough, while preventing current short-circuiting due to contact between the positive electrode and the negative electrode. The separator is, for example, a porous membrane formed of a synthetic resin or ceramic, and may be a laminated membrane in which two or more porous membranes are laminated. Examples of the synthetic resin comprise polytetrafluoroethylene, polypropylene and polyethylene, and the like.

In embodiments of the present invention, when the lithium-ion secondary battery is charged, for example, lithium ions are de-intercalated from the positive electrode and are intercalated into the negative electrode through the electrolyte impregnated in the separator. When the lithium-ion secondary battery is discharged, for example, lithium ions are de-intercalated from the negative electrode and are intercalated into the positive electrode through the electrolyte impregnated in the separator.

Hereinafter, the present application will be further described in detail in combination with specific examples, and these examples cannot be understood as limiting the scope of protection of the present application.

### Example 1

### Preparation of Negative Electrode Composite Material

Chemical vapor deposition is performed on the surface of 20 g of a silicon oxide precursor SiOₓ (x=1) material by using methane as a carbon source under a pressure of 50 Pa at a temperature of 920° C., so as to perform carbon coating treatment on the silicon oxide precursor SiOₓ (x=1) material to form 21 g of carbon-coated SiOₓ (x=1) material.

A lithium ingot and a carbon-coated SiOₓ (x=1) material are ground and mixed at a weight ratio of 20:80 under the protection of an inert argon atmosphere to form a first mixture, then the first mixture is placed in a rotary furnace and calcined for 3 h under heat preservation at 500° C. and under an argon atmosphere, such that the carbon-coated SiOₓ material is fully reacted with the lithium metal, and then heat treatment is performed at 850° C. for 3 h, to obtain a pre-lithiated SiOₓ material.

The prepared pre-lithiated SiOₓ material and hydrochloric acid with a concentration of 1 mol/L are taken and placed into a beaker at a solid content of 5 wt % and mixed to form a second mixture, and an ultrasonic treatment is first performed on the second mixture at room temperature for 30 min; and then a magnetic stirrer is used to disperse the second mixture for 48 h, then suction filtration is performed, and after the suction filtration, pure water is poured onto the substances on filter paper, and washing is performed twice in the form of suction filtration, finally, vacuum drying is performed at 120° C. for 8 hours on the substances after suction filtration, so as to obtain a negative electrode composite material.

### Preparation of Negative Electrode Sheet

4 g of the negative electrode composite material prepared by the described process is weighed; the negative electrode composite material, conductive carbon black Super-P as a conductive agent and polyacrylic acid PAA as a binder at a mass ratio of 82:8:10 are fully stirred and mixed in a suitable amount of deionized water; by adjusting same to a solid content of 42 wt %, a uniform negative electrode slurry is formed, and then the negative electrode slurry is coated on the surface of a copper foil as a negative electrode current collector, and after drying, a negative electrode sheet is obtained.

### Battery Assembling

The prepared negative electrode sheet, a separator, a lithium sheet, a gasket and a battery housing are successively stacked and injected with 100 μl of electrolyte, and sealed by a sealing machine and assembled into a half-cell required.

### Example 2

The half-cell is prepared by using the same method as that in Example 1, and the differences lie in that: a lithium ingot and a carbon-coated SiOₓ (x=1) material are ground and mixed at a weight ratio of 15:85 under the protection of an inert argon atmosphere to form a first mixture, then the first mixture is placed in a rotary furnace and calcined for 3 h under heat preservation at 450° C. and under an argon atmosphere, such that the carbon-coated SiOₓ material is fully reacted with the lithium metal, and then heat treatment is performed at 900° C. for 4 h, to obtain a pre-lithiated SiOₓ material;

The prepared pre-lithiated SiOₓ material and hydrochloric acid with a concentration of 1 mol/L are taken and placed into a beaker at a solid content of 5 wt % and mixed to form a second mixture, and an ultrasonic treatment is first performed on the second mixture at room temperature for 10 min; and then a magnetic stirrer is used to disperse the second mixture for 48 h, then suction filtration is performed, and after the suction filtration, pure water is poured onto the substances on filter paper, and washing is performed twice in the form of suction filtration, finally, vacuum drying is performed at 120° C. for 8 hours on the substances after suction filtration, so as to obtain a negative electrode composite material.

### Example 3

The half-cell is prepared by using the same method as that in Example 1, and the differences lie in that: a lithium ingot and a carbon-coated SiOₓ (x=1) material are ground and mixed at a weight ratio of 10:90 under the protection of an inert argon atmosphere to form a first mixture, then the first mixture is placed in a rotary furnace and calcined for 2 h under heat preservation at 600° C. and under an argon atmosphere, such that the carbon-coated SiOₓ material is fully reacted with the lithium metal, and then heat treatment is performed at 920° C. for 5 h, to obtain a pre-lithiated SiOₓ material;

The prepared pre-lithiated SiOₓ material and hydrochloric acid with a concentration of 1 mol/L are taken and placed into a beaker at a solid content of 15 wt % and mixed to form a second mixture, and an ultrasonic treatment is first performed on the second mixture at room temperature for 5 min; and then a magnetic stirrer is used to disperse the second mixture for 16 h, then suction filtration is performed, and after the suction filtration, pure water is poured onto the substances on filter paper, and washing is performed twice in the form of suction filtration, finally, vacuum drying is performed at 120° C. for 8 hours on the substances after suction filtration, so as to obtain a negative electrode composite material.

### Example 4

The half-cell is prepared by using the same method as that in Example 1, and the differences lie in that: a lithium ingot and a carbon-coated SiOₓ (x=1) material are ground and mixed at a weight ratio of 5:95 under the protection of an inert argon atmosphere to form a first mixture, then the first mixture is placed in a rotary furnace and calcined for 1 h under heat preservation at 400° C. and under an argon atmosphere, such that the carbon-coated SiOₓ material is fully reacted with the lithium metal, and then heat treatment is performed at 924° C. for 6 h, to obtain a pre-lithiated SiOₓ material;

The prepared pre-lithiated SiOₓ material and hydrochloric acid with a concentration of 1 mol/L are taken and placed into a beaker at a solid content of 20 wt % and mixed to form a second mixture, and an ultrasonic treatment is first performed on the second mixture at room temperature for 1 min; and then a magnetic stirrer is used to disperse the second mixture for 8 h, then suction filtration is performed, and after the suction filtration, pure water is poured onto the substances on filter paper, and washing is performed twice in the form of suction filtration, finally, vacuum drying is performed at 120° C. for 8 hours on the substances after suction filtration, so as to obtain a negative electrode composite material.

### Example 5

The half-cell is prepared by using the same method as that in Example 1, and the differences lie in that: a lithium ingot and a carbon-coated SiOₓ (x=1) material are ground and mixed at a weight ratio of 25:75 under the protection of an inert argon atmosphere to form a first mixture, then the first mixture is placed in a rotary furnace and calcined for 4 h under heat preservation at 600° C. and under an argon atmosphere, such that the carbon-coated SiOₓ material is fully reacted with the lithium metal, and then heat treatment is performed at 850° C. for 2 h, to obtain a pre-lithiated SiOₓ material;

The prepared pre-lithiated SiOₓ material and hydrochloric acid with a concentration of 1 mol/L are taken and placed into a beaker at a solid content of 5 wt % and mixed to form a second mixture, and an ultrasonic treatment is first performed on the second mixture at room temperature for 20 min; and then a magnetic stirrer is used to disperse the second mixture for 36 h, then suction filtration is performed, and after the suction filtration, pure water is poured onto the substances on filter paper, and washing is performed twice in the form of suction filtration, finally, vacuum drying is performed at 120° C. for 8 hours on the substances after suction filtration, so as to obtain a negative electrode composite material.

### Example 6

The half-cell is prepared by using the same method as that in Example 1, and the differences lie in that: a lithium ingot and a carbon-coated SiOₓ (x=1) material are ground and mixed at a weight ratio of 30:70 under the protection of an inert argon atmosphere to form a first mixture, then the first mixture is placed in a rotary furnace and calcined for 5 h under heat preservation at 600° C. and under an argon atmosphere, such that the carbon-coated SiOₓ material is fully reacted with the lithium metal, and then heat treatment is performed at 820° C. for 2 h, to obtain a pre-lithiated SiOₓ material;

The prepared pre-lithiated SiOₓ material and hydrochloric acid with a concentration of 1 mol/L are taken and placed into a beaker at a solid content of 10 wt % and mixed to form a second mixture, and an ultrasonic treatment is first performed on the second mixture at room temperature for 30 min; and then a magnetic stirrer is used to disperse the second mixture for 40 h, then suction filtration is performed, and after the suction filtration, pure water is poured onto the substances on filter paper, and washing is performed twice in the form of suction filtration, finally, vacuum drying is performed at 120° C. for 8 hours on the substances after suction filtration, so as to obtain a negative electrode composite material.

### Example 7

The half-cell is prepared by using the same method as that in Example 1, and the differences lie in that: a lithium ingot and a carbon-coated SiOₓ (x=1) material are ground and mixed at a weight ratio of 40:60 under the protection of an inert argon atmosphere to form a first mixture, then the first mixture is placed in a rotary furnace and calcined for 5 h under heat preservation at 750° C. and under an argon atmosphere, such that the carbon-coated SiOₓ material is fully reacted with the lithium metal, and then heat treatment is performed at 800° C. for 1 h, to obtain a pre-lithiated SiOₓ material;

The prepared pre-lithiated SiOₓ material and hydrochloric acid with a concentration of 1 mol/L are taken and placed into a beaker at a solid content of 5 wt % and mixed to form a second mixture, and an ultrasonic treatment is first performed on the second mixture at room temperature for 30 min; and then a magnetic stirrer is used to disperse the second mixture for 48 h, then suction filtration is performed, and after the suction filtration, pure water is poured onto the substances on filter paper, and washing is performed twice in the form of suction filtration, finally, vacuum drying is performed at 120° C. for 8 hours on the substances after suction filtration, so as to obtain a negative electrode composite material.

### Example 8

The half-cell is prepared by using the same method as that in Example 1, and the differences lie in that: a lithium ingot and a carbon-coated SiOₓ (x=1) material are ground and mixed at a weight ratio of 20:80 under the protection of an inert argon atmosphere to form a first mixture, then the first mixture is placed in a rotary furnace and calcined for 4 h under heat preservation at 550° C. and under an argon atmosphere, such that the carbon-coated SiOₓ material is fully reacted with the lithium metal, and then heat treatment is performed at 900° C. for 5 h, to obtain a pre-lithiated SiOₓ material;

The prepared pre-lithiated SiOₓ material and hydrochloric acid with a concentration of 1 mol/L are taken and placed into a beaker at a solid content of 10 wt % and mixed to form a second mixture, and an ultrasonic treatment is first performed on the second mixture at room temperature for 10 min; and then a magnetic stirrer is used to disperse the second mixture for 24 h, then suction filtration is performed, and after the suction filtration, pure water is poured onto the substances on filter paper, and washing is performed twice in the form of suction filtration, finally, vacuum drying is performed at 120° C. for 8 hours on the substances after suction filtration, so as to obtain a negative electrode composite material.

### Example 9

The half-cell is prepared by using the same method as that in Example 1, and the differences lie in that: a lithium ingot and a carbon-coated SiOₓ (x=1) material are ground and mixed at a weight ratio of 30:70 under the protection of an inert argon atmosphere to form a first mixture, then the first mixture is placed in a rotary furnace and calcined for 5 h under heat preservation at 600° C. and under an argon atmosphere, such that the carbon-coated SiOₓ material is fully reacted with the lithium metal, and then heat treatment is performed at 820° C. for 2 h, to obtain a pre-lithiated SiOₓ material;

The prepared pre-lithiated SiOₓ material and ethanol of 75% concentration are taken and placed into a beaker at a solid content of 5 wt % and mixed to form a second mixture, and an ultrasonic treatment is first performed on the second mixture at room temperature for 30 min; and then a magnetic stirrer is used to disperse the second mixture for 40 h, then suction filtration is performed, and after the suction filtration, pure water is poured onto the substances on filter paper, and washing is performed twice in the form of suction filtration, finally, vacuum drying is performed at 120° C. for 8 hours on the substances after suction filtration, so as to obtain a negative electrode composite material.

### Example 10

The half-cell is prepared by using the same method as that in Example 1, and the differences lie in that: a lithium ingot and a carbon-coated SiOₓ (x=1) material are ground and mixed at a weight ratio of 30:70 under the protection of an inert argon atmosphere to form a first mixture, then the first mixture is placed in a rotary furnace and calcined for 5 h under heat preservation at 600° C. and under an argon atmosphere, such that the carbon-coated SiOₓ material is fully reacted with the lithium metal, and then heat treatment is performed at 820° C. for 2 h, to obtain a pre-lithiated SiOₓ material;

The prepared pre-lithiated SiOₓ material and pure water are taken and placed into a beaker at a solid content of 5 wt % and mixed to form a second mixture, and an ultrasonic treatment is first performed on the second mixture at room temperature for 30 min; and then a magnetic stirrer is used to disperse the second mixture for 48 h, then suction filtration is performed, and after the suction filtration, pure water is poured onto the substances on filter paper, and washing is performed twice in the form of suction filtration, finally, vacuum drying is performed at 120° C. for 8 hours on the substances after suction filtration, so as to obtain a negative electrode composite material.

### Comparative Example 1

The half-cell is prepared by using the same method as that in Example 1, and the differences lie in that: a lithium ingot and a carbon-coated SiOₓ (x=1) material are ground and mixed at a weight ratio of 50:50 under the protection of an inert argon atmosphere to form a first mixture, then the first mixture is placed in a rotary furnace and calcined for 5 h under heat preservation at 750° C. and under an argon atmosphere, such that the carbon-coated SiOₓ material is fully reacted with the lithium metal, and then heat treatment is performed at 800° C. for 1 h, to obtain a pre-lithiated SiOₓ material;

The prepared pre-lithiated SiOₓ material and hydrochloric acid with a concentration of 1 mol/L are taken and placed into a beaker at a solid content of 5 wt % and mixed to form a second mixture, and an ultrasonic treatment is first performed on the second mixture at room temperature for 30 min; and then a magnetic stirrer is used to disperse the second mixture for 48 h, then suction filtration is performed, and after the suction filtration, pure water is poured onto the substances on filter paper, and washing is performed twice in the form of suction filtration, finally, vacuum drying is performed at 120° C. for 8 hours on the substances after suction filtration, so as to obtain a negative electrode composite material.

### Comparative Example 2

The half-cell is prepared by using the same method as that in Example 1, and the differences lie in that: a lithium ingot and a carbon-coated SiOₓ (x=1) material are ground and mixed at a weight ratio of 40:60 under the protection of an inert argon atmosphere to form a first mixture, then the first mixture is placed in a rotary furnace and calcined for 5 h under heat preservation at 750° C. and under an argon atmosphere, such that the carbon-coated SiOₓ material is fully reacted with the lithium metal, and then heat treatment is performed at 800° C. for 1 h, to obtain a pre-lithiated SiOₓ material;

The pre-lithiated SiOₓ material is not subjected to a washing treatment, and instead the pre-lithiated SiOₓ material is directly used as a negative electrode composite material.

### Comparative Example 3

The half-cell is prepared by using the same method as that in Example 1, and the differences lie in that: a lithium ingot and a carbon-coated SiOₓ (x=1) material are ground and mixed at a weight ratio of 5:95 under the protection of an inert argon atmosphere to form a first mixture, then the first mixture is placed in a rotary furnace and calcined for 1 h under heat preservation at 400° C. and under an argon atmosphere, such that the carbon-coated SiOₓ material is fully reacted with the lithium metal, and then heat treatment is performed at 1000° C. for 6 h, to obtain a pre-lithiated SiOₓ material;

The prepared pre-lithiated SiOₓ material and hydrochloric acid with a concentration of 1 mol/L are taken and placed into a beaker at a solid content of 20 wt % and mixed to form a second mixture, and an ultrasonic treatment is first performed on the second mixture at room temperature for 1 min; and then a magnetic stirrer is used to disperse the second mixture for 8 h, then suction filtration is performed, and after the suction filtration, pure water is poured onto the substances on filter paper, and washing is performed twice in the form of suction filtration, finally, vacuum drying is performed at 120° C. for 8 hours on the substances after suction filtration, so as to obtain a negative electrode composite material.

### Comparative Example 4

The half-cell is prepared by using the same method as that in Example 1, and the differences lie in that: a lithium ingot and a carbon-coated SiOₓ (x=1) material are ground and mixed at a weight ratio of 5:95 under the protection of an inert argon atmosphere to form a first mixture, then the first mixture is placed in a rotary furnace and calcined for 1 h under heat preservation at 350° C. and under an argon atmosphere, such that the carbon-coated SiOₓ material is fully reacted with the lithium metal, and then heat treatment is performed at 924° C. for 6 h, to obtain a pre-lithiated SiOₓ material;

The prepared pre-lithiated SiOₓ material and hydrochloric acid with a concentration of 1 mol/L are taken and placed into a beaker at a solid content of 20 wt % and mixed to form a second mixture, and an ultrasonic treatment is first performed on the second mixture at room temperature for 1 min; and then a magnetic stirrer is used to disperse the second mixture for 8 h, then suction filtration is performed, and after the suction filtration, pure water is poured onto the substances on filter paper, and washing is performed twice in the form of suction filtration, finally, vacuum drying is performed at 120° C. for 8 hours on the substances after suction filtration, so as to obtain a negative electrode composite material.

### Comparative Example 5

The half-cell is prepared by using the same method as that in Example 1, and the differences lie in that: a lithium ingot and a carbon-coated SiOₓ (x=1) material are ground and mixed at a weight ratio of 30:70 under the protection of an inert argon atmosphere to form a first mixture, then the first mixture is placed in a rotary furnace and calcined for 5 h under heat preservation at 600° C. and under an argon atmosphere, such that the carbon-coated SiOₓ material is fully reacted with the lithium metal, and then heat treatment is performed at 820° C. for 2 h, to obtain a pre-lithiated SiOₓ material;

The prepared pre-lithiated SiOₓ material and pure water are taken and placed into a beaker at a solid content of 5 wt % and mixed to form a second mixture; and a magnetic stirrer is used to disperse the second mixture at room temperature for 48 h, then suction filtration is performed, and after the suction filtration, pure water is poured onto the substances on filter paper, and washing is performed twice in the form of suction filtration, finally, vacuum drying is performed at 120° C. for 8 hours on the substances after suction filtration, so as to obtain a negative electrode composite material.

### Comparative Example 6

The half-cell is prepared by using the same method as that in Example 1, and the differences lie in that: a lithium ingot and a carbon-coated SiOₓ (x=1) material are ground and mixed at a weight ratio of 2:98 under the protection of an inert argon atmosphere to form a first mixture, then the first mixture is placed in a rotary furnace and calcined for 1 h under heat preservation at 400° C. and under an argon atmosphere, such that the carbon-coated SiOₓ material is fully reacted with the lithium metal, and then heat treatment is performed at 924° C. for 6 h, to obtain a pre-lithiated SiOₓ material;

The prepared pre-lithiated SiOₓ material and hydrochloric acid with a concentration of 1 mol/L are taken and placed into a beaker at a solid content of 20 wt % and mixed to form a second mixture, and an ultrasonic treatment is first performed on the second mixture at room temperature for 1 min; and then a magnetic stirrer is used to disperse the second mixture for 8 h, then suction filtration is performed, and after the suction filtration, pure water is poured onto the substances on filter paper, and washing is performed twice in the form of suction filtration, finally, vacuum drying is performed at 120° C. for 8 hours on the substances after suction filtration, so as to obtain a negative electrode composite material.

### Comparative Example 7

The half-cell is prepared by using the same method as that in Example 1, and the differences lie in that: a lithium ingot and a carbon-coated SiOₓ (x=1) material are ground and mixed at a weight ratio of 40:60 under the protection of an inert argon atmosphere to form a first mixture, then the first mixture is placed in a rotary furnace and calcined for 5 h under heat preservation at 750° C. and under an argon atmosphere, such that the carbon-coated SiOₓ material is fully reacted with the lithium metal, and then heat treatment is performed at 800° C. for 1 h, to obtain a pre-lithiated SiOₓ material;

The prepared pre-lithiated SiOₓ material and hydrochloric acid with a concentration of 1 mol/L are taken and placed into a beaker at a solid content of 5 wt % and mixed to form a second mixture, and an ultrasonic treatment is first performed on the second mixture at room temperature for 40 min; and then a magnetic stirrer is used to disperse the second mixture for 48 h, then suction filtration is performed, and after the suction filtration, pure water is poured onto the substances on filter paper, and washing is performed twice in the form of suction filtration, finally, vacuum drying is performed at 120° C. for 8 hours on the substances after suction filtration, so as to obtain a negative electrode composite material.

### Comparative Example 8

The half-cell is prepared by using the same method as that in Example 1, and the differences lie in that: a lithium ingot and a carbon-coated SiOₓ (x=1) material are ground and mixed at a weight ratio of 5:95 under the protection of an inert argon atmosphere to form a first mixture, then the first mixture is placed in a rotary furnace and calcined for 0.5 h under heat preservation at 400° C. and under an argon atmosphere, such that the carbon-coated SiOₓ material is fully reacted with the lithium metal, and then heat treatment is performed at 924° C. for 6 h, to obtain a pre-lithiated SiOₓ material;

The prepared pre-lithiated SiOₓ material and hydrochloric acid with a concentration of 1 mol/L are taken and placed into a beaker at a solid content of 20 wt % and mixed to form a second mixture, and an ultrasonic treatment is first performed on the second mixture at room temperature for 1 min; and then a magnetic stirrer is used to disperse the second mixture for 8 h, then suction filtration is performed, and after the suction filtration, pure water is poured onto the substances on filter paper, and washing is performed twice in the form of suction filtration, finally, vacuum drying is performed at 120° C. for 8 hours on the substances after suction filtration, so as to obtain a negative electrode composite material.

### Comparative Example 9

The half-cell is prepared by using the same method as that in Example 1, and the differences lie in that: a lithium ingot and a carbon-coated SiOₓ (x=1) material are ground and mixed at a weight ratio of 5:95 under the protection of an inert argon atmosphere to form a first mixture, then the first mixture is placed in a rotary furnace and calcined for 1 h under heat preservation at 400° C. and under an argon atmosphere, such that the carbon-coated SiOₓ material is fully reacted with the lithium metal, and then heat treatment is performed at 924° C. for 7 h, to obtain a pre-lithiated SiOₓ material;

The prepared pre-lithiated SiOₓ material and hydrochloric acid with a concentration of 1 mol/L are taken and placed into a beaker at a solid content of 20 wt % and mixed to form a second mixture, and an ultrasonic treatment is first performed on the second mixture at room temperature for 1 min; and then a magnetic stirrer is used to disperse the second mixture for 8 h, then suction filtration is performed, and after the suction filtration, pure water is poured onto the substances on filter paper, and washing is performed twice in the form of suction filtration, finally, vacuum drying is performed at 120° C. for 8 hours on the substances after suction filtration, so as to obtain a negative electrode composite material.

### Test of Physical Properties of Materials

The negative electrode composite materials of Examples 1-10 and Comparative Examples 1-9 are tested to obtain results of I_{D}/I_{G}, content of Li₂CO₃, content of LiOH, content of Li₂SiO₃, weight ratio of Li₂Si₂O₅ to Li₂SiO₃, i.e. Li₂Si₂O₅/Li₂SiO₃, and size of crystalline silicon.

The mass fractions of Li₂Si₂O₅ and Li₂SiO₃ are obtained by calculation according to XRD (Druker Advanced D8) test results, so as to obtain a weight ratio of Li₂Si₂O₅ to Li₂SiO₃, i.e. Li₂Si₂O₅/Li₂SiO₃.

The content of Li₂SiO₃ is calculated from an XRD spectrogram.

The size of crystalline silicon is obtained by calculation according to the XRD (Druker Advanced D8) test result (the size is obtained by calculation using a Scherrer formula by the half-peak width of crystalline silicon peak on the XRD spectrogram).

XRD test conditions: 10-80°, 1°/min.

Neutralization titration method: taking the negative electrode composite material and pure water at a mass ratio of 1:9 and placing into a beaker and mixing same, dispersing the negative electrode composite material for 1 h at room temperature by using a magnetic stirrer, standing still for 1 h, and filtering the dispersion liquid. 10 mL of the resulting filtrate is subjected to automatic titration with 0.2 M of hydrochloric acid by using an acid-base autotitrator, to obtain a first terminal point (a mL) and a second terminal point (b mL).

$$Content of {Li}_{2} {CO}_{3} =$$

$$[ amount of pure water ( g ) / amount of filtrate ( g ) ] \times 2 \times ( b / 1000 ) \times$$

$$( equivalent concentration of titration amount of hydrochloric acid \times$$

$$coefficient ) \times ( 1 / 2 ) \times$$

$$( molar mass of {Li}_{2} {CO}_{3} ) \times [ 100 ( \% ) / amount of sample ( g ) ]$$

$$Content of LiOH =$$

$$[ amount of pure water ( g ) / amount of filtrate ( g ) ] \times [ ( a - b ) / 1000 ] \times$$

$$( equivalent concentration of titration amount of hydrochloric acid \times$$

$$coefficient ) \times ( 1 / 2 ) \times$$

$$( molar mass of LiOH ) \times [ 100 ( \% ) / amount of sample ( g ) ] .$$

### Test of Battery Performance

The half-cells of Examples 1-10 and Comparative Examples 1-9 are subjected to a charge and discharge test under an environment of 25° C. at a voltage ranging from 0 V to 1.5 V. The half-cells in the examples and comparative examples are firstly subjected to a cycle test once with a charge and discharge current of 0.1C under an environment of 25° C. (the range of the charge and discharge voltage is 0 V-1.5 V), so as to determine the initial discharge capacity and the initial Coulombic efficiency of the cells; and then the cells are subjected to a charge and discharge cycle test for 50 times by using a 1C current (the charge and discharge cut-off voltage is 0 V-1.5 V), so as to determine the capacity retention rate of the cells after 50 cycles. Initial Coulombic Efficiency (%)=initial discharge capacity/initial charge capacity×100%. The experimental results are shown in Table 1 below and FIGS. 2-5.

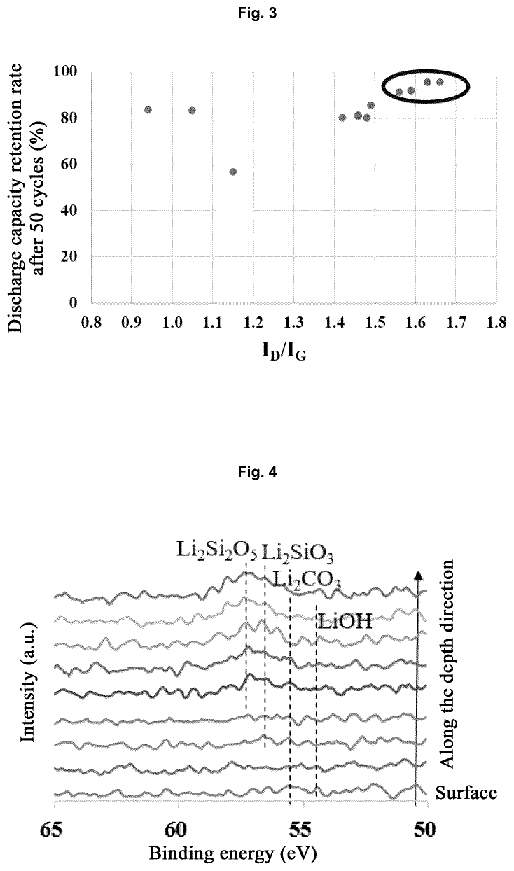

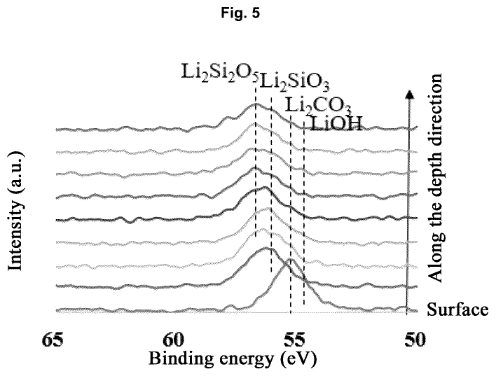

It can be seen from FIG. 2 that the relationship between the size of crystalline silicon and the weight ratio of Li₂Si₂O₅ to Li₂SiO₃, i.e. Li₂Si₂O₅/Li₂SiO₃ in the negative electrode composite material is linear. It can be seen from FIG. 3 that when the intensity ratio of a D peak to a G peak, i.e. I_{D}/I_{G} in a Raman spectrum of the negative electrode composite material is greater than about 0.8 and less than about 2.0, preferably greater than about 1.5 and less than about 1.8, better cycle performance can be obtained. In FIGS. 4 and 5, the direction from the bottom to the top is the direction from the surface to the inside. It can be seen from FIGS. 4 and 5 that water-soluble Li₂CO₃ and LiOH are substantially at the surface of the particle (since Li₂CO₃ and LiOH are few in Example 2, the signal on the XPS spectrogram of the surface is very weak), and within the particle, Li₂SiO₃ is distributed in a tendency of gradually decreasing toward the center of the particle from a position close to the surface of the particle. Other water-insoluble lithium silicate (Li₂Si₂O₅) is distributed at a position closer to the center of the particle than Li₂SiO₃.

TABLE 1
Physical properties of materials and electrochemical performance test results

| | | | | | | | | | Discharge |
|---|---|---|---|---|---|---|---|---|---|
| | | | | | Weight | Size of | Initial | Initial | capacity |
| | | Content | Content | Content | ratio of | crystalline | discharge | Coulombic | retention |
| Experiment | | of Li₂CO₃ | of LiOH | of Li₂SiO₃ | Li₂Si₂O₅ | silicon | capacity | efficiency | rate after 50 |
| No. | I_{D}/I_{G} | (wt %) | (wt %) | (wt %) | to Li₂SiO₃ | (nm) | (mAh/g) | (%) | cycles (%) |
| Example 1 | 1.59 | 0.045 | 0.009 | 15.4 | 4.06 | 6.6 | 1294 | 85.6 | 92.0 |
| Example 2 | 1.66 | 0.035 | 0.004 | 14.0 | 4.95 | 7.2 | 1285 | 87.5 | 95.4 |
| Example 3 | 1.56 | 0.130 | 0.043 | 7.1 | 9.74 | 11.3 | 1218 | 90.5 | 91.1 |
| Example 4 | 1.63 | 0.135 | 0.045 | 1.1 | 10.00 | 11.2 | 1195 | 85.3 | 95.5 |
| Example 5 | 1.59 | 0.161 | 0.099 | 24.1 | 2.54 | 6.5 | 1282 | 85.5 | 91.8 |
| Example 6 | 0.94 | 0.011 | 0.089 | 30.3 | 1.28 | 5.0 | 1305 | 89.5 | 83.6 |
| Example 7 | 1.05 | 0.388 | 0.095 | 47.9 | 1.00 | 5.1 | 1342 | 90.8 | 83.1 |
| Example 8 | 1.49 | 0.465 | 0.079 | 11.2 | 6.32 | 7.3 | 1188 | 88.8 | 85.6 |
| Example 9 | 0.91 | 0.482 | 0.098 | 30.3 | 1.28 | 5.0 | 1298 | 85.4 | 82.9 |
| Example 10 | 0.96 | 0.354 | 0.092 | 30.3 | 1.28 | 5.0 | 1332 | 85.6 | 83.1 |
| Comparative | 1.15 | 1.005 | 1.203 | 48.0 | 0.99 | 3.6 | 1256 | 84.1 | 56.8 |
| Example 1 | | | | | | | | | |
| Comparative | 1.02 | 1.001 | 3.705 | 56.4 | 0.62 | 5.1 | 1265 | 79.7 | 70.2 |
| Example 2 | | | | | | | | | |
| Comparative | 1.48 | 0.457 | 0.112 | 0.9 | 10.1 | 12.8 | 1198 | 85.0 | 80.1 |
| Example 3 | | | | | | | | | |
| Comparative | 1.46 | 0 | 0 | 0 | / | 10.1 | 1153 | 76.9 | 81.2 |
| Example 4 | | | | | | | | | |
| Comparative | 0.95 | 0.505 | 0.128 | 48.1 | 0.66 | 5.0 | 1292 | 84.2 | 81.5 |
| Example 5 | | | | | | | | | |
| Comparative | 1.48 | 0 | 0 | / | / | 3.2 | 1401 | 77.1 | 80.2 |
| Example 6 | | | | | | | | | |
| Comparative | 1.06 | 0.378 | 0.081 | 45.8 | 0.87 | 4.1 | 1198 | 84.3 | 59.2 |
| Example 7 | | | | | | | | | |
| Comparative | 1.42 | 0 | 0 | 0 | / | 10.0 | 1205 | 77.3 | 80.0 |
| Example 8 | | | | | | | | | |
| Comparative | 1.46 | 0.156 | 0.085 | 0.96 | 10.1 | 11.9 | 1203 | 84.8 | 80.6 |
| Example 9 | | | | | | | | | |

It can be seen from the test results that the examples above of the present invention achieve the following technical effects:

By comparing the results of Examples 1-10 with those of Comparative Examples 1-9, it can be seen that compared with Comparative Examples 1-9 in which based on the weight of the negative electrode active material particulates, the content of Li₂CO₃, the content of LiOH and the weight ratio of Li₂Si₂O₅ to Li₂SiO₃, i.e. Li₂Si₂O₅/Li₂SiO₃ are not completely within the ranges of the present invention, the cells in Example 1-10 in which based on the weight of the negative electrode active material particulates, the content of Li₂CO₃ is greater than about 0.01 wt % and less than about 1 wt %, the content of LiOH is greater than about 0.001 wt % and less than about 0.1 wt %, and the weight ratio of Li₂Si₂O₅ to Li₂SiO₃, i.e. Li₂Si₂O₅/Li₂SiO₃ is in the range of about 1.00 to about 10.00 have higher initial Coulombic efficiency and higher discharge capacity retention ratio after 50 cycles.

By comparing the results of Examples 1-10 with those of Comparative Example 9, it can be seen that compared with Comparative Example 9 in which based on the weight of the negative electrode active material particulates, the weight ratio of Li₂Si₂O₅ to Li₂SiO₃, i.e. Li₂Si₂O₅/Li₂SiO₃ and the content of Li₂SiO₃ are both not within the ranges of the present invention, the cells of Examples 1-10 in which based on the weight of the negative electrode active material particulates, the weight ratio of Li₂Si₂O₅ to Li₂SiO₃, i.e. Li₂Si₂O₅/Li₂SiO₃ is in the range from about 1.00 to about 10.00 and the content of Li₂SiO₃ is greater than about 1.0 wt % and less than about 48.0 wt %, have higher initial Coulombic efficiency and higher discharge capacity retention ratio after 50 cycles.

According to the results in Example 6, Example 9 and Example 10, it can be seen that by the preparation method comprising acid washing, alcohol washing or water washing treatment of the present invention, the negative electrode composite material of the present invention can be obtained, the residual lithium amount can be effectively reduced, the processing performance of the slurry can be improved, and the initial Coulombic efficiency and the discharge capacity retention rate after 50 cycles of the cells can be increased.

By comparing the results of Example 7 with those of Comparative Example 1, it can be seen that when the weight ratio of the lithium source to the carbon-coated silicon oxide is in the range of about 5:95 to about 40:60, a negative electrode composite material with a suitable Li₂CO₃ content, a suitable LiOH content, a suitable Li₂SiO₃ content and a suitable weight ratio of Li₂Si₂O₅ to Li₂SiO₃, i.e. Li₂Si₂O₅/Li₂SiO₃ can be obtained, the residual lithium amount can be effectively reduced, the processing performance of the slurry can be improved, and the initial Coulombic efficiency and the discharge capacity retention rate after 50 cycles of the cells can be increased.

By comparing the results of Example 7 with those of Comparative Example 2, it can be seen that by performing a washing treatment on the pre-lithiated SiOₓ material, a negative electrode composite material with a suitable Li₂CO₃ content, a suitable LiOH content, a suitable Li₂SiO₃ content and a suitable weight ratio of Li₂Si₂O₅ to Li₂SiO₃, i.e. Li₂Si₂O₅/Li₂SiO₃ can be obtained, the residual lithium amount can be effectively reduced, the processing performance of the slurry can be improved, and the initial Coulombic efficiency and the discharge capacity retention rate after 50 cycles of the cells can be increased.

By comparing the results of Example 4 with those of Comparative Example 3, it can be seen that when the temperature of performing the second heat treatment is in the range of greater than or equal to about 800° C. and less than about 925° C., a negative electrode composite material with a suitable LiOH content, a suitable Li₂SiO₃ content and a suitable weight ratio of Li₂Si₂O₅ to Li₂SiO₃, i.e. Li₂Si₂O₅/Li₂SiO₃ can be obtained, the size of crystalline silicon can be controlled so as to prevent the size of the crystalline silicon from being too large, the residual lithium amount can be effectively reduced, the processing performance of the slurry can be improved, and the initial Coulombic efficiency and the discharge capacity retention rate after 50 cycles of the cells can be increased.

By comparing the results of Example 4 with those of Comparative Example 4, it can be seen that when the temperature of performing the first heat treatment is in the range of about 400° C. to about 750° C., a negative electrode composite material with a suitable Li₂CO₃ content, a suitable LiOH content, a suitable Li₂SiO₃ content and a suitable weight ratio of Li₂Si₂O₅ to Li₂SiO₃, i.e. Li₂Si₂O₅/Li₂SiO₃ can be obtained, good pre-lithiation effect can be ensured and the initial Coulombic efficiency and the discharge capacity retention rate after 50 cycles of the cells can be increased. When the temperature of performing the first heat treatment is too low, it may cause failure of pre-lithiation, and may reduce the initial Coulombic efficiency of the cells.

By comparing the results of Example 10 with those of Comparative Example 5, it can be seen that when the washing treatment comprises performing an ultrasonic treatment on the second mixture, a negative electrode composite material with a suitable LiOH content, a suitable Li₂SiO₃ content and a suitable weight ratio of Li₂Si₂O₅ to Li₂SiO₃, i.e. Li₂Si₂O₅/Li₂SiO₃ can be obtained, the initial Coulombic efficiency and the discharge capacity retention rate after 50 cycles of the cells can be increased.

By comparing the results of Example 4 with those of Comparative Example 6, it can be seen that when the weight ratio of the lithium source to the carbon-coated silicon oxide is in the range of about 5:95 to about 40:60, a negative electrode composite material with a suitable Li₂CO₃ content, a suitable LiOH content, a suitable Li₂SiO₃ content and a suitable weight ratio of Li₂Si₂O₅ to Li₂SiO₃, i.e. Li₂Si₂O₅/Li₂SiO₃ can be obtained, good pre-lithiation effect can be ensured and the initial Coulombic efficiency and the discharge capacity retention rate after 50 cycles of the cells can be increased. When the weight ratio of the lithium source to the carbon-coated silicon oxide is too low, pre-lithiation may fail, lithium silicate may not be obtained, and the initial Coulombic efficiency of the cells may be reduced.

By comparing the results of Example 7 with those of Comparative Example 7, it can be seen that when the time of performing the ultrasonic treatment is in the range of about 1 min to about 30 min, a negative electrode composite material with a suitable weight ratio of Li₂Si₂O₅ to Li₂SiO₃, i.e. Li₂Si₂O₅/Li₂SiO₃, can be obtained, crushing of the particles can be avoided, and the initial Coulombic efficiency and the discharge capacity retention rate after 50 cycles of the cells can be increased.

By comparing the results of Example 4 with those of Comparative Example 8, it can be seen that when the time of performing the first heat treatment is in the range of about 1 h to about 5 h, a negative electrode composite material with a suitable Li₂CO₃ content, a suitable LiOH content, a suitable Li₂SiO₃ content and a suitable weight ratio of Li₂Si₂O₅ to Li₂SiO₃, i.e. Li₂Si₂O₅/Li₂SiO₃ can be obtained, good pre-lithiation effect can be ensured and the initial Coulombic efficiency and the discharge capacity retention rate after 50 cycles of the cells can be increased.

By comparing the results of Example 4 with those of Comparative Example 9, it can be seen that when the time of performing the second heat treatment is in the range of about 1 h to about 6 h, a negative electrode composite material with a suitable Li₂SiO₃ content and a suitable weight ratio of Li₂Si₂O₅ to Li₂SiO₃, i.e. Li₂Si₂O₅/Li₂SiO₃ can be obtained, the size of crystalline silicon can be controlled so as to prevent the size of the crystalline silicon from being too large, and the initial Coulombic efficiency and the discharge capacity retention rate after 50 cycles of the cells can be increased.

It can be seen from the described battery performance test results: by the negative electrode composite material, the method for preparing the negative electrode composite material, and the negative electrode and the lithium-ion secondary battery which contain the negative electrode composite material in the present invention, the residual lithium amount can be effectively reduced, the processing performance of the slurry can be improved, and the initial Coulombic efficiency and cycle performance of the lithium-ion secondary battery can be improved.

The content as described above is only preferred embodiments of the present invention and is not intended to limit the present invention. For a person skilled in the art, the present invention may have various modifications and variations. Any modifications, equivalent replacements, improvements, etc. made within the spirit and principle of the present invention shall all fall within the scope of protection of the present invention.

1. A negative electrode composite material, wherein the negative electrode composite material comprises negative electrode active material particulates and Li₂CO₃ and LiOH at the surface of the negative electrode active material particulates, the negative electrode active material particulates comprise:
particles containing silicon oxide, Li₂SiO₃ and Li₂Si₂O₅; and
a carbon coating layer coating at least a part of surface of the particles,
based on the weight of the negative electrode active material particulates, the content of Li₂CO₃ is greater than about 0.01 wt % and less than about 1 wt %, the content of LiOH is greater than about 0.001 wt % and less than about 0.1 wt %, and the weight ratio of Li₂Si₂O₅ to Li₂SiO₃, i.e. Li₂Si₂O₅/Li₂SiO₃ is in the range of about 1.00 to about 10.00.

2. The negative electrode composite material according to claim 1, wherein based on the weight of the negative electrode active material particulates, the content of Li₂SiO₃ is greater than about 1.0 wt % and less than about 48.0 wt %.

3. The negative electrode composite material according to claim 1, wherein within the particles, Li₂SiO₃ is distributed in a tendency of gradually decreasing toward the center of the particles from a position close to the surface of the particles, and Li₂Si₂O₃ is distributed at a position closer to the center of the particles than Li₂SiO₃.

4. The negative electrode composite material according to claim 1, wherein the carbon coating layer coats the entire surface of the particles.

5. The negative electrode composite material according to claim 1, wherein the silicon oxide is SiOₓ, where about 0.5≤x≤about 1.6.

6. The negative electrode composite material according to claim 1, wherein silicon in the silicon oxide exists in the form of crystalline silicon, and the size of the crystalline silicon is in the range of about 5.0 nm to about 12.0 nm.

7. The negative electrode composite material according to claim 1, wherein the intensity ratio of a D peak to a G peak, i.e. I_{D}/I_{G} in a Raman spectrum of the negative electrode composite material is greater than about 0.8 and less than about 2.0, preferably greater than about 1.5 and less than about 1.8.

8. The negative electrode composite material according to claim 1, wherein the coating amount of the carbon coating layer is in the range of about 1 wt % to about 30 wt % based on the weight of the negative electrode active material particulates.

9. A method for preparing a negative electrode composite material, wherein the method comprises:
performing carbon coating treatment on a silicon oxide precursor by using a carbon source, to form carbon-coated silicon oxide;
mixing the carbon-coated silicon oxide with a lithium source to form a first mixture, performing a first heat treatment on the first mixture to form a calcined product, and then performing a second heat treatment on the calcined product to form a pre-lithiated product; and
performing a washing treatment on the pre-lithiated product to form the negative electrode composite material.

10. The method for preparing the negative electrode composite material according to claim 9, wherein the washing treatment comprises mixing the pre-lithiated product with water, alcohol or an acid, preferably at a solid content of about 5 wt % to about 20 wt %, to form a second mixture, performing an ultrasonic treatment on the second mixture, then dispersing same, subsequently performing suction filtration, and finally drying the substances after suction filtration.

11. The method for preparing the negative electrode composite material according to claim 10, wherein the acid is selected from at least one of hydrochloric acid, citric acid, oxalic acid, phosphoric acid, sulfurous acid, acetic acid, chloric acid, hypochlorous acid and boric acid.

12. The method for preparing the negative electrode composite material according to claim 9, wherein the weight ratio of the lithium source to the carbon-coated silicon oxide is in the range of about 5:95 to about 40:60.

13. The method for preparing the negative electrode composite material according to claim 9, wherein the temperature of performing the first heat treatment is in the range of about 400° C. to about 750° C., and the time of performing the first heat treatment is in the range of about 1 h to about 5 h.

14. The method for preparing the negative electrode composite material according to claim 9, wherein the temperature of performing the second heat treatment is in the range of greater than or equal to about 800° C. and less than about 925° C., and the time of performing the second heat treatment is in the range of about 1 h to about 6 h.

15. The method for preparing the negative electrode composite material according to claim 10, wherein the time of performing the ultrasonic treatment is in the range of about 1 min to about 30 min.

16. The method for preparing the negative electrode composite material according to claim 10, wherein the time for the dispersion is in the range of about 8 h to about 48 h.

17. The method for preparing the negative electrode composite material according to claim 9, wherein the carbon source comprises at least one of an alkane, an olefin and an alkyne.

18. The method for preparing the negative electrode composite material according to claim 10, wherein the alcohol is selected from at least one of ethanol, isopropanol and butanol.

19. A lithium-ion secondary battery, wherein the lithium ion secondary battery comprises:
a positive electrode,
a negative electrode, and
a separator,
wherein the negative electrode comprises the negative electrode composite material according to claim 1.
